(19) United States
(12) Patent Application Publication
(10) Pub. No.: US 2009/0263437 A1
(43) Pub. Date: Oct. 22, 2009

(54) PESTICIDE COMPOSITIONS

(76) Inventor: Giora TALMOR, Moshav Netaim (IL)

Correspondence Address: BROWDY AND NEIMARK, P.L.L.C.;624 NINTH STREET, NW, SUITE 300, WASHINGTON, DC, 20001-5303, US

(21) Appl. No.: 12/424,988

(22) Filed: Apr. 16, 2009

Related U.S. Application Data
(60) Provisional application No. 61/052,657, filed on May 13, 2008.

(30) Foreign Application Priority Data
Apr. 16, 2008 (IL) 190912

(51) Int. Cl. A01N 25/12; A01N 53/06; A01P 7/00

(52) U.S. Cl. 424/405; 514/531

(57) ABSTRACT

The present invention provides a granular pesticide composition which is highly effective in controlling pests. In particular, the pesticide composition of the present invention is prepared by adsorbing an oil in water emulsion on inert granular particles. These compositions provide improved release of the pesticide. Methods of preparing the granular pesticide composition and methods of use thereof are disclosed.

### FIELD OF THE INVENTION

The present invention relates generally to granular pesticide compositions comprising an inert carrier and more specifically provides a pesticide formulation prepared from an emulsion composition adsorbed on inert granular particles.

### BACKGROUND OF THE INVENTION

Pesticides or insecticides can be applied in a variety of forms. Aqueous applications are often utilized as aqueous emulsions or suspensions due to the low miscibility of many of the pesticide formulations in water. Pesticides dissolved in organic solvents are rarely used mainly due to environmental considerations.

Macro- as well as micro-emulsions are known to be highly unstable for prolonged usage. The emulsions tend to separate into phases thus providing non-uniform formulations. In order to avoid phase separation, many of the pesticides are formulated as emulsion concentrates which are subsequently emulsified to form emulsions prior to their use. The emulsion concentrates usually contain the active ingredient in an organic solvent, together with one or more surfactants to facilitate emulsification upon introduction of water.

Many factors affect the formation of emulsions, including the physical and chemical properties of the different constituents as well as their relative concentrations within the composition. Preparation of emulsions in situ is thus complicated, resulting in emulsified compositions with large variability. The variations influence the quality of the formulation as the concentration of the active ingredient as well as of the desirable dosage of use differs from one preparation to another.

U.S. Pat. No. 5,317,042 discloses aqueous microemulsions which are obtained by providing an inert matrix composition containing a defined mixture of the active ingredient with surfactants to form a microemulsion concentrate which is subsequently diluted with water prior to its use. U.S. Pat. No. 6,541,516 discloses clear, high load water miscible emulsions of insecticides, as a single phase translocatable composition which is free of xylene and alkylphenol ethoxylate surfactants. U.S. Pat. No. 6,716,443 discloses emulsions prepared using phase inversion temperature methods. The emulsions contain pesticides and nonionic emulsifiers which may readily be diluted with water. U.S. Pat. No. 6,451,731 discloses a concentrate composition which is substantially non-aqueous, comprising a pesticide suspension concentrate containing a liquid pesticide of low solubility in water in which a solid particulate pesticide is dispersed, further comprising a stabilizing suspension aid along with an emulsifying agent for subsequent dilution with water.

Alternatively, pesticides may be applied in a solid particulate form. In this manner of application, the solid particles are dispersed on top of desired surfaces. The release of the active ingredient is often facilitated through the application of water. Particle size can vary from thin dust to granular particles.

The preparation of solid particulate pesticides is performed via the adsorption of the active ingredient in the molten state or alternatively immersed in an organic solvent, on an inert carrier material such as clay or the like. Another commonly used manner of preparation includes the incorporation of the active ingredients into a suitable carrier thus obtaining prolonged release of the active ingredients.

U.S. Pat. No. 3,849,105 discloses a method of producing a granular pesticide formulation from an oleaginous suspension of a solid water-insoluble pesticide dispersed in a continuous water phase. The process involves spraying of said suspension on inert granular carrier followed by an inversion process wherein the water is absorbed by the granules and the oleaginous component along with the active pesticide are adhered to the wetted particle surface.

U.S. Pat. No. 5,705,193 discloses a process for the preparation of insecticide granules comprising the dissolution of the active principle in an aromatic solvent or pyrrolidone, absorbing the resulting solution on a support, optionally adding water thereto and drying the resulting product to form the granules. There is neither teaching nor suggestion of an emulsion composition used for the preparation of said granules.

U.S. Pat. No. 5,326,560 discloses an insecticide composition comprising an insecticide carrier composed from a mixture of diatomaceous earth as a solid extender and petrolatum as a semi-solid extender. A diluent, such as crop oil, may be further added to the mixture, particularly for use as an oil spray formulation.

Many of the solid particulate formulations suffer from low efficacy. Main attributions are incomplete release of the active ingredient from its carrier, decomposition of active ingredient upon exposure to sun and heat, and drift of light particles due to wind. International Patent Application WO 2005/060756 teaches a manner of increasing the efficacy of cellulose-based granule pesticide by mixing the active ingredient with surfactant followed by the adsorption on the cellulose-based carrier (Biodac®). According to this disclosure, the cellulose matrix, which constitutes the granules, possesses strong affinity to the active ingredient (a synthetic pyrethroid) thus reducing its accessibility to the surrounding. The incorporation of a surfactant interferes with the strong affinity/binding thus restoring the activity to acceptable levels. A similar result was obtained using another pyrethroid compound, permethrin as the active ingredient along with several nonionic surfactants adsorbed on Biodac® granules (Stern A J, J. ASTM International, 3(1), JAI12918, 2006). There is neither teaching nor suggestion of an emulsion composition comprising active ingredients adsorbed on an inert carrier. Furthermore, no inert carrier other than cellulose-based granular carrier in disclosed in these publications.

Hence, there is an unmet need for a highly efficient solid particulate pesticide. Furthermore, there is an unmet need for a pesticide composition comprising an inert pesticide carrier that provides better release of the active ingredient upon watering.

### SUMMARY OF THE INVENTION

The present invention provides a pesticide composition comprising an inert carrier. Specifically, the invention provides a pesticide formulation prepared from an emulsion composition comprising an emulsion concentrate comprising the pesticide dissolved in an organic solvent with emulsifiers emulsified in water, which is adsorbed onto inert granular particles. The composition is a highly efficient particulate pesticide formulation which provides greatly improved release of the active ingredient upon exposure to watering. The invention further provides methods of preparing and methods of use of said granular pesticides.

The invention is based in part on the unexpected finding that adsorption of an aqueous emulsion composition comprising the active ingredient on inert granular particles followed by dehydration provides a more effective pesticide composition. In particular, the pesticide composition of the present invention provides enhanced release of the active ingredient with the application of water in comparison to known compositions in which the active ingredient is merely dissolved in organic solvents and adsorbed on inert granular particles. Thus, it is now disclosed for the first time that a dried granular pesticide composition formed by adsorption of an emulsified pesticide concentrate and subsequent dehydration has unexpected superior properties compared to known compositions formed without emulsification.

According to one aspect, the present invention provides a granular pesticide composition comprising in weight percent of the total composition: a) 90-99.9% inert non-cellulosic granular material; b) a dried emulsion composition comprising 0.01-2.5% active pesticide ingredient and 0.01-10% emulsifiers.

In one embodiment, the present invention provides a granular pesticide composition formed by adsorbing an emulsion composition comprising emulsion concentrate emulsified in water on inert granular particles followed by dehydration.

In another embodiment, the granular pesticide composition of the present invention further comprises from about 0.1 to about 20% of low molecular weight saccharides. In some embodiments, the low molecular weight saccharides are selected from the group consisting of sucrose, fructose, glucose and dextrose.

According to certain embodiments, the pesticide composition comprises at least one active ingredient. Active ingredients within the scope of the present invention are insecticides, nematicides, herbicides, molluscicides and mixtures thereof. Specifically, said active pesticide ingredients include, but are not limited to, profenofos, dichlorvos, fenamiphos, fenitrothion, EPN, diazinon, chlorpyrifos, acephate, prothiofos, fosthiazate, cadusafos, dislufoton, isoxathion, isofenphos, ethion, etrimfos, quinalphos, dimethylvinphos, dimethoate, sulprofos, thiometon, vamidothion, pyraclofos, pyridaphenthion, pirimiphos-methyl, propaphos, phosalone, formothion, malathion, tetrachlovinphos, chlorfenvinphos, cyanophos, trichlorfon, methidathion, phenthoate, dimethylethylsulfilisopropyl thiophosphate (ESP), azinphos-methyl, fenthion, heptenophos, methamidphos, paration, carbaryl, propoxur, aldicarb, carbofuran, thiodicarb, methomyl, oxamyl, ethiofencarb, pirimicarb, fenobucarb, carbosulfan, benfuracarb, bendiocarb, furathiocab, isoprocarb, metolcarb, xylylcarb, 3,5-xylylmethyl carbamate (XMC), imidacloprid, nitenpyram, acetamiprid, thiacloprid, thiamethoxam, clothianidin, dinotefuran, 1-(6-chloro-3-pyridylmethyl)-2-(1-nitro-2-allylthioethylidene)imidazolidine, diflubenzuron, chlorfluazuron, teflubenzuron, flufenoxuron, triflumuron, hexaflumuron, lufenuron, novaluron, and mixtures thereof.

In currently preferred embodiments, the at least one active ingredient comprises synthetic pyrethroid compounds selected from the group consisting of etofenprox, fenvalerate, pyrethrins, flucythrinate esfenvalerate, fenpropathrin, cypermethrin, permethrin, protrifenbute cyhalothrin, λ-cyhalothrin, deltamethrin, cycloprothrin, fluvalinate, bifenthrin, 2-methyl-2-(4-bromodifluoromethoxyphenyl)propyl(3-phenoxybenzyl)ether, tralomethrin, silafluofen, d-phenothrin, cyphenothrin, resmethrin, acrinathrin, cyfluthrin, tefluthrin, transfluthrin, tetramethrin, allethrin, d-furamethrin, prallethrin, empenthrin, 5-(2-propynyl)furfuryl 2,2,3,3-tetramethylcyclopropanecarboxylate, and mixtures thereof.

In some embodiments, the inert granular particles are selected from the group consisting of Fullers earth, ground natural minerals including kaolins, clays (e.g. kaolin clay, diatomaceous earth, synthetic hydrated silicon oxide, bentonite, Fubasami clay and acid clay), talc, ceramics, sericite, sulfur, chalk, quartz, attapulgite, montmorillonite, vermiculite, and ground synthetic minerals, including highly-dispersed silicic acid, active carbon, calcium carbonate, hydrated silicon oxide, alumina and silicates, crushed and fractionated natural rocks including calcite, aragonite, marble, pumice, sepiolite and dolomite. Additional carriers include chemical fertilizers (e.g. ammonium sulfate, ammonium phosphate, ammonium nitrate, urea and ammonium chloride). Combinations of the inert solid carriers hereinabove are within the scope of the present invention.

These inert carriers encompass a wide range of densities as well as particle size range. The granular pesticide compositions of the present invention can thus be tailored to specific use. In particular, the size of the granules can be designed according to the soil upon which it is used, in order to ensure penetration of the active pesticide ingredient to a desired depth.

In one embodiment, the granular pesticide composition comprises particles having a particle size in the range of 0.01 to 1.5 mm.

In other embodiments the emulsifiers used for the formation of the emulsion compositions of the present invention are selected from non-ionic and anionic emulsifiers, and mixtures thereof.

In yet other embodiments, the non-ionic emulsifiers are selected from the group consisting of polyalkylene glycol ethers, condensation products of alkyl/aryl phenols, aliphatic alcohols, aliphatic amines with ethylene oxide, fatty acids with ethylene oxide, and propylene oxides including, but not limited to, the ethoxylated alkyl phenols and carboxylic esters solubilized with polyol or polyoxyalkylene. In a currently preferred embodiment, the non-ionic emulsifier is the ethoxylated Castor oil with 40 moles of ethylene oxide.

In still other embodiments, the anionic emulsifiers are selected from the group consisting of oil-soluble salts (e.g., calcium, magnesium and the like) of alkyl/aryl sulphonic acids, oil soluble salts of sulphated polyglycol ethers and appropriate salts of phosphated polyglycol ether. In a currently preferred embodiment, the anionic emulsifier is the calcium salt of dodecyl benzene sulfonates with isobutanol.

According to another aspect, the present invention provides a method for preparing the granular composition of the present invention comprising the steps of: a) preparing an emulsion concentrate comprising an active pesticide ingredient, organic solvents and emulsifiers; b) emulsifying the emulsion concentrate with aqueous medium to form an emulsion composition; c) adding a non-cellulosic granular carrier; and d) drying said composition.

In some embodiments, the granular pesticide composition of the present invention is prepared by the method disclosed herein above.

In various embodiments, the organic solvents used for the preparation of the emulsion concentrate comprise aromatic hydrocarbons and derivatives thereof including, but not limited to, 1-methylnaphthalene, tetrahydronaphthalene, decahydronaphthalene, 2-methylnaphthalene or dimethylnaphthalene, alkylbenzenes, xylene, benzyltoluene. Other solvents include aliphatic hydrocarbons, mineral or vegetable oils, alcohols, ethers, ketones, amides, esters, mono and dialkyl phthalates, pyrrolidones or derivatives thereof. Preferably, mixtures of these solvents, including, but not limited to, Surfadone LP 100®, Marlotherm S®, Marlotherm L®, Solvesso 200® and the like are used. In a currently preferred embodiment, the solvent mixture is Solgard 150ULN®.

In certain embodiments, the step of drying the emulsion composition comprises heating said composition to a temperature range of 50-80° C. until essentially no loss of weight is observed.

According to another aspect, the present invention provides a method of controlling pests comprising the application of effective amount of a granular pesticide composition comprising: a) 90-99.9% inert non-cellulosic granular particles; b) a dried emulsion composition comprising 0.01-2.5% active pesticide ingredient and 0.01-10% emulsifiers, to habitats of pests.

Examples of pest ants to which the compositions of the present inventions are designated include all ant species belonging to the family Formicidae, particularly fire ants (Solenopsis spp.), argentine ants (Linepithema humile), pharaoh ants (Monomorium pharaonis), little black ants (Monomorium spp.), carpenter ants (Camponotus spp.), ghost ants and odorous house ants (Tapinoma spp.), big-headed ants (Pheidole spp.), white-footed ants (Technomyrmex albipes), small honey ants (Prenolepis impairs), acrobat ants (Crematogaster spp.), pyramid ants (Dorymyrmex spp.), cornfield ants (Lasius alienus), desert ants (Cataglyphis niger), harvesting ants (Messor spp.) and pavement ants (Tetramorium caespitum).

Within the scope of the present invention is the control of insect pests of the order Isoptera (termites) including, but not limited to, various species of Mastotermitidae, Hodotermitidae, Hodotermitinae, Kalotermitidae, Termopsidae, Termopsinae, Porotermitinae, Stolotermitinae, Rhinotermitidae, Coptotermitinae, Heterotermitinae, Prorhinoterminae, Psammotermitinae, Rhinotermitinae, Stylotermitinae, Termitogetoninae, Serritermitidae, Termitidae, Macrotermitinae, Nasutitermitinae, Amitermitinae, Apicotermitinae, Cubitermitinae, and Termitinae. Other insects are foliar feeding larvae and adults of the order Coleoptera including, but not limited to, species of Anthribidae, Bruchidae, Curculionidae, Chrysomelidae, Cerambycidae, Anobiidae, Scaribaeidae, Dermestidae, Elateridae, Scolytidae, Scarabaeidae and Tenebrionidae. Additional insects are the grasshoppers, crickets and locusts from the order Orthoptera including, but not limited to, Prophalangopsidae, Rhaphidophoridae, Schizodactylidae, Anostostomatidae, Cooloolidae, Gryllacrididae, Gryllotalpidae, Stenopelmatidae, Tettigoniidae, Romaleidae, Tetrigidae, and Cylindrachetidae.

Additional pests within the scope of the present invention are larvae of the order Lepidoptera including, but not limited to, species of Lymantriidae, and Tortricidae, and adults and larvae of the order Dermaptera including earwigs from the family Forficulida.

In other embodiments, the composition of the present invention is spread over specific areas including, but not limited to, lawns, gardens, and sidewalks. According to preferred embodiments, the release of active ingredients is increased upon watering.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### DETAILED DESCRIPTION OF THE INVENTION

The compositions and methods described herein provide granular pesticides prepared from an emulsion composition adsorbed on an inert carrier. Specifically, the invention provides a pesticide formulation wherein said formulation comprises inert non-cellulosic granular material and a dried emulsion composition comprising active pesticide ingredient and emulsifiers. The invention further provides a method of preparing highly efficient particulate pesticides wherein better release of the active ingredient upon watering is achieved. Methods of use of said granular pesticides for controlling pests are disclosed as well.

According to the principles of the present invention, the pesticide composition is prepared by the adsorption of an oil in water emulsion composition on inert granular particles. Unexpectedly, the adsorption of an oil in water emulsion instead of the adsorption of an emulsion concentrate or other organic-based compositions allows better release of the active ingredient upon water application. Hence, the pesticide composition of the present invention provides enhanced efficacy in controlling pests.

According to a first aspect, the present invention provides a granular pesticide composition comprising: a) 90-99.9% inert non-cellulosic granular material; b) a dried emulsion composition comprising 0.01-2.5% active pesticide ingredient and 0.01-10% emulsifiers.

According to one embodiment, the pesticide composition comprises at least one active pesticide ingredient. Suitable active pesticide ingredients include, but are not limited to, profenofos, dichlorvos, fenamiphos, fenitrothion, EPN, diazinon, chlorpyrifos, acephate, prothiofos, fosthiazate, cadusafos, dislufoton, isoxathion, isofenphos, ethion, etrimfos, quinalphos, dimethylvinphos, dimethoate, sulprofos, thiometon, vamidothion, pyraclofos, pyridaphenthion, pirimiphos-methyl, propaphos, phosalone, formothion, malathion, tetrachlovinphos, chlorfenvinphos, cyanophos, trichlorfon, methidathion, phenthoate, dimethylethylsulfilisopropyl thiophosphate (ESP), azinphos-methyl, fenthion, heptenophos, methamidphos, paration, carbaryl, propoxur, aldicarb, carbofuran, thiodicarb, methomyl, oxamyl, ethiofencarb, pirimicarb, fenobucarb, carbosulfan, benfuracarb, bendiocarb, furathiocab, isoprocarb, metolcarb, xylylcarb, 3,5-xylylmethyl carbamate (XMC), imidacloprid, nitenpyram, acetamiprid, thiacloprid, thiamethoxam, clothianidin, dinotefuran, 1-(6-chloro-3-pyridylmethyl)-2-(1-nitro-2-allylthioethylidene)imidazolidine, diflubenzuron, chlorfluazuron, teflubenzuron, flufenoxuron, triflumuron, hexaflumuron, lufenuron, novaluron, combinations and mixtures thereof.

Specifically, the active pesticide ingredients comprise synthetic pyrethroid compounds including, but not limited to, etofenprox, fenvalerate, pyrethrins, flucythrinate esfenvalerate, fenpropathrin, cypermethrin, permethrin, protrifenbute cyhalothrin, λ-cyhalothrin, deltamethrin, cycloprothrin, fluvalinate, bifenthrin, 2-methyl-2-(4-bromodifluoromethoxyphenyl)propyl (3-phenoxybenzyl)ether, tralomethrin, silafluofen, d-phenothrin, cyphenothrin, resmethrin, acrinathrin, cyfluthrin, tefluthrin, transfluthrin, tetramethrin, allethrin, d-furamethrin, prallethrin, empenthrin and 5-(2-propynyl)furfuryl 2,2,3,3-tetramethylcyclopropanecarboxylate, and mixtures thereof. In a currently preferred embodiment, the active pesticide ingredient is bifenthrin.

In some embodiments, the emulsion composition is adsorbed on inert granular particles which are used as solid carriers. The terms “inert particles” or “inert solid carriers” as used herein refer to solid particles including, but is not limited to, Fullers earth, ground natural minerals such as kaolins, clays (e.g. kaolin clay, diatomaceous earth, synthetic hydrated silicon oxide, bentonite, Fubasami clay and acid clay), talc, ceramics, sericite, sulfur, chalk, quartz, attapulgite, montmorillonite, vermiculite, and ground synthetic minerals, such as highly-dispersed silicic acid, active carbon, calcium carbonate, hydrated silicon oxide, alumina and silicates, crushed and fractionated natural rocks such as calcite, aragonite, marble, pumice, sepiolite and dolomite, as well as synthetic granules of inorganic and organic materials, provided that the organic materials are essentially devoid of cellulosic components. The term “non-cellulosic” as used herein refers to particles which comprise less than 10%, preferably less than 5%, more preferably less than 2.5% and most preferably less than 1% cellulose-based components.

Additional carriers include chemical fertilizers (e.g. ammonium sulfate, ammonium phosphate, ammonium nitrate, urea and ammonium chloride). In a currently preferred embodiment, the granular particles are a mixture of calcium carbonates and silicates, most preferably vermiculite and calcite.

These inert carriers encompass a wide range of densities as well as particle size distributions. According to the principles of the present invention, the inert carriers are granular particles wherein the size of the granules is designed according to the soil upon which it is used, in order to ensure penetration of the active pesticide ingredient to a desired depth. The term “granular particles” as used herein refers to particles having a particle size distribution in the range of about 0.01 to about 1.5 mm. More preferably the granular particles have a particle size distribution in the range of about 0.25 to about 1.2 mm. Most preferably the granular particles have a particle size distribution in the range of about 0.5 to about 1 mm.

In another embodiment, the granular pesticide composition of the present invention further comprises from 0.1-20% of low molecular weight saccharides. The term “low molecular weight saccharides” as used herein refers to simple sugars (e.g. monosaccharides, disaccharides and the like) of the general formula (CH₂O)ₙ. The saccharides can be straight-chain or ring systems, and can include a saccharose unit of the formula —CH(OH)—C(═O)—. Examples of saccharides include erythrose, threose, ribose, arabinose, xylose, lyxose, allose, altrose, glucose, mannose, gulose, idose, galactose, talose, erythulose, ribulose, xyulose, psicose, fructose, sorbose, tagatose, erythropentulose, threopentulose, glycerotetrulose, glucopyranose, fructofuranose, etc.

In currently preferred embodiments, the low molecular weight saccharides are selected from the group consisting of sucrose, fructose, glucose and dextrose. Without being bound by any theory or mechanism of action, the saccharides are added to the composition as insect baits.

In particular embodiments, the granular pesticide composition of the present invention is formed by adsorbing an oil in water emulsion composition comprising emulsified emulsion concentrate on inert granular particles followed by dehydration.

The term “emulsion” or interchangeably “emulsion composition” as used herein refers to a dispersion of oil in water (“o/w”). According to the invention, the term “oil” as used herein refers to any hydrophobic substance which is insoluble or very sparingly soluble in water and which can be made into a stable aqueous emulsion of the oil-in-water type, optionally using a surfactant. Within the scope of the present invention is a macroemulsion or a microemulsion. A macroemulsion is a cloudy turbid composition having an oil-droplet size of about 0.5 to about 100 μm and is generally thermodynamically unstable. In comparison, a microemulsion is a translucent to transparent composition having a droplet size of 0.005 to 0.5 μm, is thermodynamically stable and is generally self emulsifying. The emulsion composition, according to the principles of the present invention is a biphasic composition comprising oil droplets dispersed in a continuous aqueous phase. In certain embodiments, the term “emulsion composition” as used herein also refers to continuous aqueous phase that contains a discontinuous organic phase wherein the discontinuous phase comprises discrete micelles in the range of about 0.001 to about 0.5 micrometers.

In some embodiments the emulsifiers used for the formation of the emulsion composition of the present invention comprises at least one of non-ionic and anionic emulsifiers. In a currently preferred embodiment, the emulsion composition of the present invention comprises a mixture of non-ionic and anionic emulsifiers.

The term “non-ionic emulsifier” as used herein refers to surfactant substances which comprise a hydrophobic tail portion, usually having a long hydrocarbon chain and an uncharged hydrophilic head group. The non-ionic emulsifiers within the scope of the present invention are polyalkylene glycol ethers, condensation products of alkyl/aryl phenols, aliphatic alcohols, aliphatic amines with ethylene oxide, fatty acids with ethylene oxide, and propylene oxides including, but not limited to, the ethoxylated alkyl phenols and carboxylic esters solubilized with polyol or polyoxyalkylene. In a currently preferred embodiment, the non-ionic emulsifier is the ethoxylated Castor oil with 40 moles of ethylene oxide.

According to the principles of the present invention, the non-ionic emulsifiers are usually mixed with anionic emulsifiers to form the emulsion concentrate. The term “anionic emulsifier” as used herein refers to surfactant substances which comprise a hydrophobic tail portion, usually having a long hydrocarbon chain, and a hydrophilic polar head group, with negatively charged head groups. The anionic emulsifiers are selected from the group consisting of oil-soluble salts (e.g., calcium, magnesium and the like) of alkyl/aryl sulphonic acids, oil soluble salts or sulphated polyglycol ethers and appropriate salts of phosphated polyglycol ether. Other anionic surfactants include, but are not limited to, alkyl benzene sulfonates, alkyl ether sulfonates, alkyl sulfosuccinates, alkyl ether sulfosuccinates, olefin sulfonates, alkyl sarcosinates, alkyl monoglyceride sulfates, ether sulfates, alkyl ether carboxylates, paraffinic sulfonates, mono- and di-alkyl phosphate esters and ethoxylated derivatives, acyl methyl taurates, fatty acid soaps, clooagen hydrosylate derivatives, sulfoacetates, acyl lactates, aryloxide disulfonates, sulfosuccinamides, naphthaleneformaldehyde condensates and the like. In a currently preferred embodiment, the anionic emulsifier is the calcium salt of dodecyl benzene sulfonates with isobutanol.

Alternatively, the non-ionic emulsifiers can be mixed with cationic emulsifiers to form the emulsion concentrate. Cationic emulsifiers include, but are not limited to, quaternary ammonium compounds and fatty amines.

According to another aspect, the present invention provides a method for preparing the granular composition of the present invention comprising the steps of: a) preparing an emulsion concentrate comprising an active pesticide ingredient, organic solvents and emulsifiers; b) emulsifying the emulsion concentrate in water to form an emulsion composition; c) adding a non-cellulosic granular carrier; and d) drying said composition.

The method disclosed herein comprises the preparation of the granular pesticide composition of the present invention from oil in water emulsion. The emulsion is prepared by mixing an emulsion concentrate comprising the active pesticide ingredient dissolved in an organic solvent and further comprising emulsifiers, with water. The granular pesticide composition of the present invention is then prepared by adsorbing the emulsion on inert granular carriers and subsequent drying.

According to the principles of the present invention, the emulsion composition is prepared by dilution in water and emulsification of an emulsion concentrate. The term “emulsion concentrate” refers to the organic phase of the emulsion prior to dilution and emulsification with an aqueous phase. Typically, the emulsion concentrate comprises the organic solvent and the emulsifiers in which the active ingredients are dissolved. The emulsion concentrate of the present invention comprises 1-20% active pesticide ingredient, 65-95% organic solvents and 1-20% emulsifiers. More preferably, the emulsion concentrate of the present invention comprises 5-15% active pesticide ingredient, 70-90% organic solvents and 5-15% emulsifiers.

The emulsion composition is then mixed with inert granular carriers to provide a composition comprising 1-20% water, 0.01-2% active pesticide ingredient, 0.01-9.5% emulsifiers and organic solvents and 85-99% granular particles. The composition is then dried to result in a pesticide composition comprising 90-99.9% inert non-cellulosic granular material, 0.01-2.5% active pesticide ingredient, 0.01-10% emulsifiers. The composition may further comprise dried organic solvents.

According to certain embodiments, drying the emulsion composition comprises heating said composition to a temperature range of 50-80° C. until essentially no loss of weight is observed.

In some embodiments, the organic solvents used for the preparation of the emulsion concentrate comprise aromatic hydrocarbons and derivatives thereof including, but not limited to, 1-methylnaphthalene, tetrahydronaphthalene, decahydronaphthalene, 2-methylnaphthalene or dimethylnaphthalene, alkylbenzenes, xylene, benzyltoluene. Other solvents include aliphatic hydrocarbons, mineral or vegetable oils, alcohols, ethers, ketones, amides, esters, mono and dialkyl phthalates, pyrrolidones or derivatives thereof. Preferably, mixtures of these solvents, including, but not limited to, Surfadone LP 100®, Marlotherm S®, Marlotherm L®, Solvesso 200® and the like are used. In a currently preferred embodiment, the solvent mixture is Solgard 150ULN®.

An “alkyl” group refers to a saturated aliphatic hydrocarbon, including straight-chain, branched-chain and cyclic alkyl groups. In one embodiment, the alkyl group has 1-11 carbons designated here as C₁-C₁₁-alkyl. In another embodiment, the alkyl group has 1-9 carbons designated here as C₁-C₉-alkyl. The alkyl group may be unsubstituted or substituted by one or more groups selected from halogen, haloalkyl, acyl, amido, ester, cyano, nitro, and azido.

An “aryl” group refers to an aromatic monocyclic or multicyclic ring system. In one embodiment, the aryl group has 6-10 carbon atoms. The aryl is optionally substituted at least one “ring system substituents” and combinations thereof, and are as defined herein. Exemplary aryl groups include phenyl or naphthyl. An alkylaryl is an alkyl group as defined herein bonded to an aryl group as defined herein. The aryl group can be unsubstituted or substituted through available carbon atoms with one or more groups defined hereinabove for alkyl.

“Ring system substituents” refer to substituents attached to aromatic or non-aromatic ring systems including, but not limited to, H, halo, haloalkyl, (C₁-C₈)alkyl, (C₆-C₁₀)aryl, acyl, amido, ester, cyano, nitro, azido, and the like.

An “amine” moiety refers to an —NRR′ group, wherein R and R′ are independently selected from hydrogen, alkyl and aryl. A currently preferred amine group is —NH₂. An “alkylamine” group is an alkyl group as defined herein bonded to an amine group as defined herein.

An “amide” moiety refers to a —C(O)NRR′ group wherein R and R′ are independently selected from hydrogen, alkyl and aryl. An “alkylamide” group is an alkyl group as defined herein bonded to an amide group as defined herein.

An “ammonium” moiety refers to —NH₄⁺ group.

An “acyl” moiety encompasses groups such as, but not limited to, formyl, acetyl, propionyl, butyryl, pentanoyl, pivaloyl, hexanoyl, heptanoyl, octanoyl, nonanoyl, decanoyl, undecanoyl, dodecanoyl, benzoyl and the like. Currently preferred acyl groups are acetyl and benzoyl.

A “thio” or “thiol” moiety refers to —SH group or, if between two other groups, —S—. A “thioalkyl” group is an alkyl group as defined herein bonded to a thiol group as defined herein.

A “sulfonyl” or “sulfone” moiety refers to —S(O)₂— group. An “alkylsulfone” group is an alkyl group as defined herein bonded to a sulfonyl group as defined herein.

A “sulfonate” moiety refers to a —S(O)₂O— group.

A “carboxy” or “carboxyl” moiety refers carboxylic acid and derivatives thereof including in particular, ester derivatives and amide derivatives. A “carboxyalkyl” group is an alkyl group as defined herein bonded to a carboxy group as defined herein.

A “carboxylate” moiety refers to a —COO⁻ group, optionally having a positively charged counter ion present.

A “keto” or “keton” moiety refers to a —C(O)— group.

An “alcohol” moiety refers to an —OH group.

A “phosphate” moiety refers to a PO₄ group wherein the bond to the parent moiety is through the oxygen atoms.

In yet another aspect, the present invention provides a method of controlling pests comprising the application of effective amount of a granular pesticide composition comprising: a) 90-99.9% inert non-cellulosic granular particles; b) a dried emulsion composition comprising 0.01-2.5% active pesticide ingredient and 0.01-10% emulsifiers to habitats of pests.

The term “pests” refers to various species of arthropods, gastropods and nematodes. The term “arthropod” includes, but is not limited to, insects, mites, spiders, scorpions, centipedes, millipedes, pill bugs and symphylans. The term “gastropod” includes, but is not limited to, snails, slugs and other Stylommatophora. The term “nematode” includes, but is not limited to, all of the helminths, e.g. roundworms, heartworms, and phytophagous nematodes (Nematoda), flukes (Trematoda), Acanthocephala, and tapeworms (Cestoda).

The compositions of the present invention are particularly useful as insecticides of insect pests of the order Hymenoptera including, but not limited to, all ant species belonging to the family Formicidae, particularly fire ants (Solenopsis spp.), little fire ant (Wasmannia auropunctata), argentine ants (Linepithema humile), pharaoh ants (Monomorium pharaonis), little black ants (Monomorium spp.), carpenter ants (Camponotus spp.), ghost ants and odorous house ants (Tapinoma spp.), big-headed ants (Pheidole spp.), white-footed ants (Technomyrmex albipes), small honey ants (Prenolepis impairs), acrobat ants (Crematogaster spp.), pyramid ants (Dorymyrmex spp.), cornfield ants (Lasius alienus), desert ants (Cataglyphis niger), harvesting ants (Messor spp.) and pavement ants (Tetramorium caespitum). Additionally, insect pests of the order Isoptera including, but not limited to, the eastern subterranean, western subterranean termite, Formosan subterranean termite, and West Indian drywood termite. Examples of insect pests of the order Isoptera (termites) include, but not limited to, species of Mastotermitidae, Hodotermitidae, Hodotermitinae, Kalotermitidae, Termopsidae, Termopsinae, Porotermitinae, Stolotermitinae, Rhinotermitidae, Coptotermitinae, Heterotermitinae, Prorhinoterminae, Psammotermitinae, Rhinotermitinae, Stylotermitinae, Termitogetoninae, Serritermitidae, Termitidae, Macrotermitinae, Nasutitermitinae, Amitermitinae, Apicotermitinae, Cubitermitinae, and Termitinae.

Other insects for which the compositions is designated to are foliar feeding larvae and adults of the order Coleoptera including, but not limited to, species of weevils from the families Anthribidae, Bruchidae, Curculionidae, flea beetles, cucumber beetles, rootworms, leaf beetles, potato beetles, and leafminers in the family Chrysomelidae, Cerambycidae, Anobiidae, Scaribaeidae, carpet beetles from the family Dermestidae, wireworms from the family Elateridae, bark beetles from the family Scolytidae, western corn rootworm, chafers and other beetles from the family Scarabaeidae and flour beetles from the family Tenebrionidae.

Additional insects are the grasshoppers, crickets and locusts from the order Orthoptera including, but not limited to, Prophalangopsidae, Rhaphidophoridae, Schizodactylidae, Anostostomatidae, Cooloolidae, Gryllacrididae, Gryllotalpidae, Stenopelmatidae, Tettigoniidae, Romaleidae, Tetrigidae, and Cylindrachetidae.

Within the scope of the present invention are larvae of the order Lepidoptera including, but not limited to, armyworms, cutworms, loopers, and heliothines in the family Noctuidae: borers, casebearers, webworms, coneworms, cabbageworms and skeletonizers from the family Pyralidae: leafrollers, budworms, seed worms, and fruit worms in the family Tortricidae; Nymphs and adults of the order Blattodea including, but not limited to, cockroaches from the families Blattellidae and Blattidae, and adults and larvae of the order Dermaptera including earwigs from the family Forficulida.

In other embodiments, the present invention provides use of effective amount of a granular pesticide composition comprising: a) 90-99.9% inert non-cellulosic granular material; b) a dried emulsion composition comprising 0.01-2.5% active pesticide ingredient and 0.01-10% emulsifiers, for controlling pests.

In yet other embodiments, the granular pesticide composition of the present invention is spread over specific areas including, but not limited to, lawns, gardens, and sidewalks. According to currently preferred embodiments, the release of active ingredients is increased upon watering.

It should be noted that, as used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise. All percentages used herein are weight percentages (W/W) known to those skilled in the art, and so forth.

The principles of the present invention are demonstrated by means of the following non-limitative examples.

### EXAMPLES

### Example 1

### Preparation of the Granular Pesticide Composition of the Present Invention

The granular pesticide composition of the present invention was prepared as follows:

Preparation of the emulsion concentrate: 10 gr/L of Bifenthrin Technical (100% active ingredient) were mixed with anionic emulsifier, Emulsion Cal 70 (calcium dodecyl benzene sulfonate with isobutanol), and non-ionic emulsifier, Emulsion CO40 (Castor oil ethoxylated with 40 mole of ethylene oxide). The mixture was then dissolved in approximately 720 gr/L of an aromatic organic solvent Solgad150ULN® (Ultra-Low Naphthalene C₉-C₁₁, Aromatic hydrocarbons, total aromatic content 99% w/w) to obtain the emulsion concentrate of the present invention.

Preparation of the granular pesticide: Inert carriers of calcium carbonate (620 g) and silicate (360 g) were mixed for approximately 5 minutes. In a separate vessel 20 g of fructose were dissolved in 50 g of H₂O. The emulsion concentrate was then added to the stirred solution (300-2000 rpm). A thick emulsion was obtained. The emulsion was added to the mixed inert carrier vessel with constant stirring to obtain a wet granular material. Stirring was performed while the granular composition was dried through hot air flow (50-80° C.). The drying process continued until no significant weight loss was observed.

### Example 2

### Comparative Quantitative Analysis of Granular Pesticide Water Extracts

The granular pesticide composition of the present invention was compared to Talstar® granules, a commercially available product. Both compositions contain Bifenthrin as the active ingredient at a concentration of 0.2%. Each of the products was immersed in an equivalent amount of water and stirred for an identical time interval. The granules were then filtered in both products and the water extracts were quantitatively analyzed for Bifenthrin concentrations using HPLC analysis with a UV detector.

While the concentration of the active ingredient in both products is similar, the water extracts of the granular composition of the present invention showed 20 times more Bifenthrin than the water extracts from Talstar® product (Table 1).

TABLE 1
Quantitative HPLC analysis of bifenthrin in
granular products and their water extracts.

| Sample | % Bifenthrin |
|---|---|
| The granular pesticide of the present invention | 0.28 |
| Talstar ® granules | 0.24 |
| Water extract of the granular pesticide of the present | 0.01 |
| invention | |
| Water extract of Talstar ® granules | 0.0005 |

### Example 3

### Comparative Quantitative Analysis of Active Ingredient Released from Granular Pesticide Upon Rinsing

The granular pesticide composition of the present invention and Talstar® granules were each placed in a glass tube and were rinsed with approximately 1 L of water. Water samples were collected and quantitatively analyzed for Bifenthrin concentrations using HPLC analysis with a UV detector. The experiment was repeated wherein the samples of the granular pesticide composition of the present invention and Talstar® granules were each rinsed with approximately 500 mL of water and approximately 250 mL of water to assess the release profile of the active ingredient using varying quantities of water.

The granular composition of the present invention released approximately 10, 14 and 11 times more Bifenthrin than the Talstar® product upon rinsing with approximately 1 L, 500 mL and 250 mL water, respectively (Table 2). The granular pesticide composition of the present invention allows a significantly better release of the active ingredient with the application of water at different quantities and is thus more effective than the known product.

TABLE 2
Quantitative HPLC analysis of bifenthrin released
from granular products upon rinsing

| Sample | % Bifenthrin |
|---|---|
| The granular pesticide of the present invention | 0.3 |
| Talstar ® granules | 0.25 |
| Water sample (1 L) from the granular pesticide of the | 0.004 |
| present invention | |
| Water sample (1 L) from Talstar ® granules | 0.0003 |
| Water sample (500 mL) from the granular pesticide of | 0.007 |
| the present invention | |
| Water sample (500 mL) from Talstar ® granules | 0.0005 |
| Water sample (250 mL) from the granular pesticide of | 0.01 |
| the present invention | |
| Water sample (250 mL) from Talstar ® granules | 0.0009 |

### Example 4

### Field Test A of the Granular Pesticide

The granular pesticide composition of the present invention containing 0.2% bifenthrin was tested for its efficacy against harvesting ants (Messor ebeninus) in a heavy moist ground following a single application. The composition was further compared to Talstar® granules product (0.2% bifenthrin).

Approximately 20 gr/nest of the granular composition were spread on ant nests with 1-4 nest holes. A comparable treatment was performed with Talstar® granules. Controls were performed via monitoring of comparable untreated nests. The results represent three duplicates. To facilitate release of the active ingredient, the granules were rinsed with approximately 1 liter of water per nest.

A day after application, a single nest treated with the granular composition of the present invention continued to show activity. All other nests were inactive. In nests treated with Talstar® granules, all nests but one showed ceased activity. In one nest, workers and brood were evacuating the nest to found a new colony not far from the treated nest. In the control nests regular activity was detected.

Approximately 96 hours post-treatment, no activity was observed in any of the nests treated with the granular composition of the present invention. In the nests treated with Talstar® granules no activity was detected except for regular activity in the newly formed nest. In the control nests regular activity continued. The nests treated with the granular composition of the present invention were examined 10 days after treatment and no activity was detected. The composition is thus shown to be effective in a single application.

### Example 5

### Field Test B of the Granular Pesticide

The granular pesticide composition of the present invention containing 0.2% bifenthrin was tested for its efficacy against desert ants (Cataglyphis niger) in a dry lawn following a single application. The composition was further compared to Talstar® granules product and Pyrinex® granules containing 5% chlorpyrifos as the active ingredient.

Approximately 20 gr/nest of the granular composition were spread on ant nests with 1-4 nest holes. A comparable treatment was performed with Talstar® granules and Pyrinex® granules. Controls were performed via monitoring of comparable untreated nests. The results represent three replicates. To facilitate release of the active ingredient, the granules were rinsed with approximately 1 liter of water per nest. Rain fell three days after application.

In the first few hours after application, an immediate effect on all treated nests was observed excluding the control nests in which regular activity was detected. The nests treated with the granular composition of the present invention and those treated with Talstar® granules and Pyrinex® granules either showed no activity or increased activity including evacuation of workers from the nests. Approximately 24 hours after treatment no activity was observed. In control nests the activity continued as normal including lack of activity due to the rain and restored activity afterwards. Nests were monitored over two weeks during which no activity was renewed in treated nests. The granular composition of the present invention is thus effective in a single application.

### Example 6

### Field Test C of the Granular Pesticide

The granular pesticide composition of the present invention containing 0.2% bifenthrin was tested for its efficacy against odorous house ants (Tapinoma israele) in dried pavement slits following a single application. The composition was further compared to Talstar® granules (0.2% bifenthrin) and Pyrinex® granules containing 5% chlorpyrifos as the active ingredient.

Approximately 20 gr/nest of the granular composition were spread on ant nests with 1-6 nest holes. A comparable treatment was performed with Talstar® granules and Pyrinex® granules. Controls were performed via monitoring of comparable untreated nests. The results represent three replicates. To facilitate release of the active ingredient, the granules were rinsed with approximately 1 liter of water per nest. Rain fell two days after application.

In the first few hours after application, an immediate ceasing of activity was observed in all treated nests excluding the control nests in which regular activity was detected. A newly formed nest appeared near one of the nests treated with the granular composition of the present invention several days after treatment. This nest was either a newly formed one or the relocated treated nest. Treatment of this nest with the composition of the present invention caused all activities to cease. Nests were monitored for two weeks during which no activity was renewed in treated nests. The granular composition of the present invention thus showed high efficacy in exterminating odorous house ants.

### Example 7

### Field Test D of the Granular Pesticide

The granular pesticide composition of the present invention containing 0.2% bifenthrin was tested for its efficacy against harvesting ants (Messor ebeninus) in a moist ground near a wheat field following a single application. The composition was further compared to Talstar® granules (0.2% bifenthrin) product and Pyrinex® granules containing 5% chlorpyrifos as the active ingredient.

Approximately 20 gr/nest of the granular composition were spread on ant nests with 1-4 nest holes surrounded with seeds. A comparable treatment was performed with Talstar® granules and Pyrinex® granules. Controls were performed via monitoring of comparable untreated nests. The results represent four replicates. To facilitate release of the active ingredient, the granules were rinsed with approximately 1 liter of water per nest. Light rain fell several days after application.

Approximately 24 hours after treatment one nest treated with Talstar® granules and all nests treated with Pyrinex® granules showed activity. On the contrary, no activity was observed in all nests treated with the granular composition of the present invention. A week after application all nests showed no activity except for one newly formed nest not far from the nest treated with Pyrinex® granules. Two weeks after application four newly formed nests appeared in the vicinity (less than 1 meter) of the nests treated with Pyrinex® granules. In contrast, no activity was observed in any of the nests treated with the granular composition of the present invention as well as those treated with Talstar® granules. In the control nests a regular activity was detected.

Nests were observed for three weeks during which no activity was renewed in the nests treated with the granular composition of the present invention. The composition is thus effective against harvesting ants in a single application.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

1. A granular pesticide composition comprising in weight percent of the total composition:
(i) 90-99.9% inert non-cellulosic granular particles; and
(ii) a dried emulsion composition comprising 0.01-2.5% active pesticide ingredient and 0.01-10% emulsifiers.

2. The granular pesticide composition according to claim 1, wherein the composition is a dehydrated oil in water emulsion composition adsorbed on inert granular particles.

3. The granular pesticide composition according to claim 1, wherein said particles have a size range of about 0.01 to about 1.5 mm.

4. The granular pesticide composition according to claim 1, further comprising from about 0.1% to about 20% of low molecular weight saccharides.

5. The granular pesticide composition according to claim 4, wherein the low molecular weight saccharides are selected from the group consisting of sucrose, fructose, glucose and dextrose.

6. The granular pesticide composition according to claim 1, wherein the active pesticide ingredient comprises synthetic pyrethroid compounds selected from the group consisting of etofenprox, fenvalerate, pyrethrins, flucythrinate esfenvalerate, fenpropathrin, cypermethrin, permethrin, protrifenbute cyhalothrin, λ-cyhalothrin, deltamethrin, cycloprothrin, fluvalinate, bifenthrin, 2-methyl-2-(4-bromodifluoromethoxyphenyl)propyl(3-phenoxybenzyl)ether, tralomethrin, silafluofen, d-phenothrin, cyphenothrin, resmethrin, acrinathrin, cyfluthrin, tefluthrin, transfluthrin, tetramethrin, allethrin, d-furamethrin, prallethrin, empenthrin, 5-(2-propynyl)furfuryl 2,2,3,3-tetramethylcyclopropanecarboxylate, and mixtures thereof.

7. The granular pesticide composition according to claim 1, wherein the inert granular particles are selected from the group consisting of Fullers earth, diatomaceous earth, synthetic hydrated silicon oxide, kaolin clay, Fubasami clay, acid clay, bentonite, talc, ceramics, sericite, sulfur, chalk, quartz, attapulgite, montmorillonite, vermiculite, highly-dispersed silicic acid, active carbon, calcium carbonate, hydrated silicon oxide, alumina, silicates, calcite, aragonite, marble, pumice, sepiolite, dolomite, and mixtures and combinations thereof.

8. The granular pesticide composition according to claims 1, wherein the emulsifiers comprise at least one of non-ionic and anionic emulsifiers.

9. The granular pesticide composition according to claim 8, wherein the non-ionic emulsifiers are selected from the group consisting of polyalkylene glycol ethers, condensation products of alkyl/aryl phenols, aliphatic alcohols, aliphatic amines with ethylene oxide, fatty acids with ethylene oxide, propylene oxides and combinations thereof.

10. The granular pesticide composition according to claim 8, wherein the non-ionic emulsifier is ethoxylated Castor oil with ethylene oxide.

11. The granular pesticide composition according to claim 8, wherein the anionic emulsifiers are selected from oil-soluble salts of alkyl/aryl sulphonic acids, sulphated polyglycol ethers, phosphated polyglycol ether and mixtures thereof.

12. The granular pesticide composition according to claim 8, wherein the anionic emulsifier is the calcium salt of dodecyl benzene sulfonates with isobutanol.

13. A method of preparing a granular pesticide composition comprising the steps of:
i) preparing an emulsion concentrate comprising an active pesticide ingredient, organic solvents and emulsifiers;
ii) emulsifying the emulsion concentrate with aqueous medium to form an oil in water emulsion composition;
iii) adding a non-cellulosic granular carrier; and
iv) drying said composition.

14. The method according to claims 13, wherein the granular composition comprises particles having a particle size range of about 0.01 to about 1.5 mm.

15. The method according to claim 13, wherein the aqueous medium comprises a solution of low molecular weight saccharides.

16. The method according to claim 15, wherein the low molecular weight saccharides are selected from the group consisting of sucrose, fructose, glucose and dextrose.

17. The method according to claim 13, wherein the active pesticide ingredient comprises synthetic pyrethroid compounds selected from the group consisting of etofenprox, fenvalerate, pyrethrins, flucythrinate esfenvalerate, fenpropathrin, cypermethrin, permethrin, protrifenbute cyhalothrin, λ-cyhalothrin, deltamethrin, cycloprothrin, fluvalinate, bifenthrin, 2-methyl-2-(4-bromodifluoromethoxyphenyl)propyl(3-phenoxybenzyl)ether, tralomethrin, silafluofen, d-phenothrin, cyphenothrin, resmethrin, acrinathrin, cyfluthrin, tefluthrin, transfluthrin, tetramethrin, allethrin, d-furamethrin, prallethrin, empenthrin, 5-(2-propynyl)furfuryl 2,2,3,3-tetramethylcyclopropanecarboxylate, and mixtures thereof.

18. The method according to claim 13, wherein the non-cellulosic granular carrier is selected from the group consisting of Fullers earth, diatomaceous earth, synthetic hydrated silicon oxide, kaolin clay, Fubasami clay, acid clay, bentonite, talc, ceramics, sericite, sulfur, chalk, quartz, attapulgite, montmorillonite, vermiculite, highly-dispersed silicic acid, active carbon, calcium carbonate, hydrated silicon oxide, alumina, silicates, calcite, aragonite, marble, pumice, sepiolite, dolomite, and mixtures and combinations thereof.

19. The method according to claim 13, wherein the emulsifiers comprise at least one of non-ionic and anionic emulsifiers.

20. The method according to claim 19, wherein the non-ionic emulsifier is ethoxylated Castor oil with ethylene oxide.

21. The method according to claim 19, wherein the anionic emulsifier is the calcium salt of dodecyl benzene sulfonates with isobutanol.

22. A granular pesticide composition prepared according to the method of claim 13.

23. A method of controlling pests comprising the application of an effective amount of a granular pesticide composition comprising in weight percent of the total composition: (i) 90-99.9% inert non-cellulosic granular particles; and (ii) a dried emulsion composition comprising 0.01-2.5% active pesticide ingredient and 0.01-10% emulsifiers, to habitats of pests.

24. The method according to claim 23, wherein the pests are insects selected from the group consisting of Formicidae, Isoptera, Coleoptera, Orthoptera, larvae of Lepidoptera, and Forficulida.
